(19) United States
(12) Patent Application Publication
(10) Pub. No.: US 2021/0157487 A1
(43) Pub. Date: May 27, 2021

(54) Storage System Having Storage Engines and Disk Arrays Interconnected by Redundant Fabrics

(71) Applicant: EMC IP HOLDING COMPANY LLC, Hopkinton, MA (US)

(72) Inventors: James Guyer, Northboro, MA (US); Jason Duquette, Milford, MA (US); Alesia Tringale, Worcester, MA (US); Sean Pollard, Methuen, MA (US); Julie Zhivich, Westborough, MA (US); Jinxian Xian, Hopkinton, MA (US); William Baxter, Holliston, MA (US)

(21) Appl. No.: 16/691,795

(22) Filed: Nov. 22, 2019

(51) Int. Cl. G06F 3/06; G06F 12/1081

(52) U.S. Cl. CPC G06F 3/0617; G06F 3/0653; G06F 12/1081; G06F 3/0619; G06F 3/067; G06F 3/0689

(57) ABSTRACT

A storage system includes four storage engines, each storage engine including two compute nodes. Eight point-to-point connections are used to interconnect pairs of compute nodes on different storage engines, such that each compute node is connected to exactly two other compute nodes of the storage system. Atomic operations can be initiated by any compute node on any other compute node. Atomic operations received by a compute node on one of the point-to-point connections will be forwarded on the other point-to-point connection if the atomic operation is not directed to the compute node. During normal operation, atomic operations on a given compute node are performed on a host adapter associated with the compute node. Upon failure of the host adapter associated with the compute node, atomic operations may be performed on the compute node using the host adapter of the other compute node of the storage engine.

### BACKGROUND

This disclosure relates to computing systems and related devices and methods, and, more particularly, to a storage system having storage engines and disk arrays interconnected by redundant fabrics to enable inter-processor messaging, atomic accessibility to metadata, inter-node data movement, and NVMeoF shared access to solid state drives.

### SUMMARY

The following Summary and the Abstract set forth at the end of this application are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

In some embodiments, a storage system includes a plurality of storage engines, each storage engine having two compute nodes, and a plurality of disk arrays. Two redundant fabrics interconnect each of the compute nodes with each of the disk arrays. The fabric enables simultaneous inter-node reliable messaging and the ability to atomically read, atomically write, and perform complex atomic operations on metadata contained in memory on any node of the storage system. The fabric also enables the ability to copy small to large blocks of data to and from a node's local memory from and to any other compute node's memory. The NVMeoF protocol is used to access, simultaneously from any node, to or from any solid-state drive in the storage system.

In some embodiments, the data movement elements are provided with hardware assisted end-to-end data consistency protection in the form of DIF, that ensures that data stored in volatile and non-volatile elements is checked for consistency every time it is accessed and moved from location to location within the storage system. Together, these features allow one fabric to provide all the system intercommunication services, as well as accelerate in time and reduce processor workload to SSD data, faster access to and manipulation of system metadata, and faster access to and manipulation of data cached within the storage system.

In some embodiments, to support high availability, two fabrics are used simultaneously active-active with all end-point interfaces dual-ported, one port to each of the individual fabrics. This combination of features lowers system cost and reduces cabling complexity with one form of fabric, and because the amount of work to do a task is reduced, allows a system to deliver the same performance at reduced cost or gives increased performance at the same cost.

### BRIEF DESCRIPTION OF THE DRAWINGS

FIG. 1 is a functional block diagram of an example storage system connected to a host computer, the storage system including storage engines and disk arrays interconnected by redundant fabrics, according to some embodiments.

FIG. 2 is a functional block diagram of a fabric access module of a storage engine, according to some embodiments.

FIG. 3 is a functional block diagram a storage system having a pair of storage engines connected to a pair of disk arrays by redundant fabrics, according to some embodiments.

FIG. 4 is a functional block diagram of the storage system of FIG. 3 showing compute node to compute node messaging, according to some embodiments.

FIG. 5 is a functional block diagram of the storage system of FIG. 3 showing disk array to compute node messaging, according to some embodiments.

FIG. 6 is a functional block diagram of the storage system of FIG. 3 showing a metadata read operation by compute node 4 from compute node 1, according to some embodiments.

FIG. 7 is a functional block diagram of the storage system of FIG. 3 showing a metadata write operation by compute node 3 to compute node 1, according to some embodiments.

FIG. 8 is a functional block diagram of the storage system of FIG. 3 showing metadata atomic read/modify/write operation for compute node 4 of compute node 1 memory, according to some embodiments.

FIG. 9 is a functional block diagram of the storage system of FIG. 3 showing a RDMA read operation of compute node 2 memory by compute node 3, according to some embodiments.

FIG. 10 is a functional block diagram of the storage system of FIG. 3 showing a RDMA write operation of compute node 2 memory by compute node 3, according to some embodiments.

FIG. 11 is a functional block diagram of the storage system of FIG. 3 showing a NVMeoF read operation by compute node 2 on disk array 1, according to some embodiments.

FIG. 12 is a functional block diagram of the storage system of FIG. 3 showing a NVMeoF write operation by compute node 2 to disk array 1, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g. and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, software, computer instructions that are stored on a non-transitory tangible computer-readable medium and implemented by multi-purpose tangible processors, and any combinations thereof.

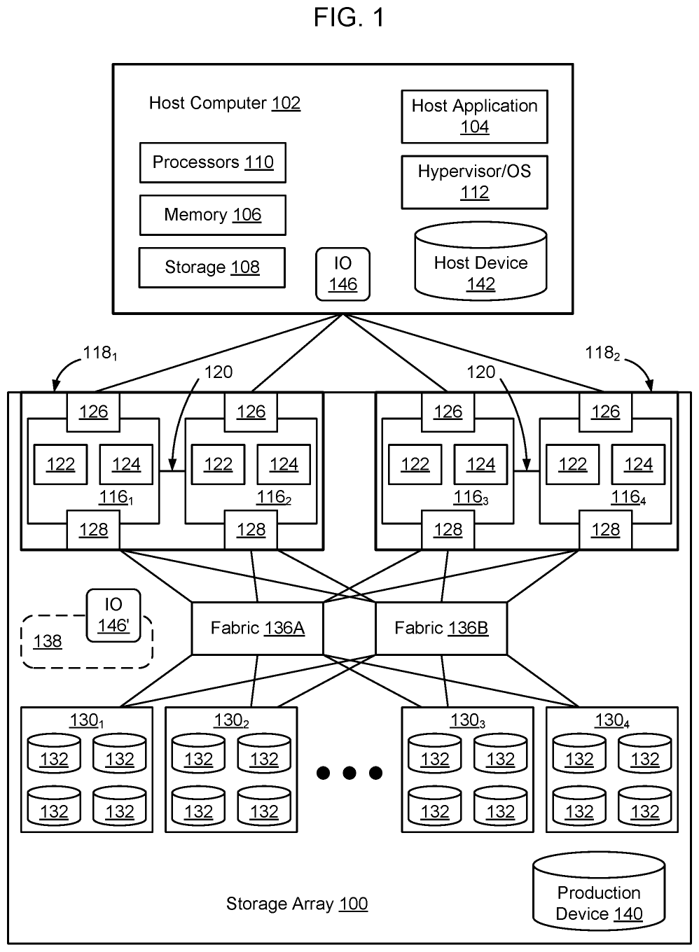

FIG. 1 illustrates a storage system 100 and an associated host computer 102, of which there may be many. The storage system 100 provides data storage services for a host application 104, of which there may be more than one instance and type running on the host computer 102. In the illustrated example the host computer 102 is a server with volatile memory 106, persistent storage 108, one or more tangible processors 110, and a hypervisor or OS (operating system) 112. The processors 110 may include one or more multi-core processors that include multiple CPUs, GPUs, and combinations thereof. The volatile memory 106 may include RAM (Random Access Memory) of any type. The persistent storage 108 may include tangible persistent storage components of one or more technology types, for example and without limitation Solid State Drives (SSDs) and Hard Disk Drives (HDDs) of any type, including but not limited to SCM (Storage Class Memory), EFDs (enterprise flash drives), SATA (Serial Advanced Technology Attachment) drives, and FC (Fibre Channel) drives. The host computer 102 might support multiple virtual hosts running on virtual machines or containers, and although an external host computer 102 is illustrated, in some embodiments host computer 102 may be instantiated in a virtual machine within storage system 100.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one or multiple storage engines 118.

Each compute node, 116₁, 116₂, 116₃, 116₄, includes processors 122 and a local volatile memory 124. The processors 122 may include a plurality of multi-core processors of one or more types, e.g. including multiple CPUs, GPUs, and combinations thereof. The local volatile memory 124 may include, for example and without limitation, any type of RAM. Each compute node 116 may also include one or more FEs (front end adapters) 126 for communicating with the host computer 102.

Each compute node 116₁-116₄ may also include one or more fabric access module 128. Fabric access module 128 enables the compute nodes 116₁-116₄ to communicate with each other over fabric 136, and also enables the compute nodes 116₁-116₄ to communicate with disk arrays 130₁-130₄ over fabric 136, thereby enabling access to managed drives 132. An example interconnecting fabric may be implemented using InfiniBand.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using Non-Volatile Memory (NVM) media technologies, such as NAND-based flash, or higher-performing Storage Class Memory (SCM) media technologies such as 3D XPoint and Resistive RAM (ReRAM). In some embodiments, each drive is a dual ported NVMe drive, with each port connected to an NVMe over Fabric interface that is itself connected to each fabric. The drive ports and fabric are all 100% active-active and fully redundant.

Each compute node 116 may allocate a portion or partition of its respective local volatile memory 124 to a virtual shared “global” memory 138 that can be accessed by other compute nodes 116, e.g. via Direct Memory Access (DMA) or Remote Direct Memory Access (RDMA). In some embodiments, compute nodes 116 can also implement atomic operations on their own memory or on the memory of any other compute node 116.

The storage system 100 maintains data for the host applications 104 running on the host computer 102. For example, host application 104 may write host application data to the storage system 100 and read host application data from the storage system 100 in order to perform various functions. Examples of host applications 104 may include but are not limited to file servers, email servers, block servers, and databases. Logical storage devices are created and presented to the host application 104 for storage of the host application data. For example, in some embodiments, a production device 140 and a corresponding host device 142 are created to enable the storage system 100 to provide storage services to the host application 104.

The host device 142 is a local (to host computer 102) representation of the production device 140. Multiple host devices 142 associated with different host computers 102 may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (logical block addresses) on which data used by the host application 104 resides and can be stored. However, the data used by the host application 104 and the storage resources available for use by the host application 104 may actually be maintained by the compute nodes 116₁-116₄ at non-contiguous addresses on various different managed drives 132 on storage system 100.

In some embodiments, the storage system 100 maintains metadata that indicates, among various things, mappings between the production device 140 and the locations of extents of host application data in the shared global memory 138 and the managed drives 132. In response to an IO (input/output command) 146 from the host application 104 to the host device 142, the hypervisor/OS 112 determines whether the IO 146 can be serviced by accessing the host computer memory 106. If that is not possible then the IO 146 is sent to one of the compute nodes 116 to be serviced by the storage system 100.

There may be multiple paths between the host computer 102 and the storage system 100, e.g. one path per front end adapter 126. The paths may be selected based on a wide variety of techniques and algorithms including, for context and without limitation, performance and load balancing. In the case where IO 146 is a read command, the storage system 100 uses metadata to locate the commanded data, e.g. in the shared global memory 138 or on managed drives 132. If the commanded data is not in the shared global memory 138, then the data is temporarily copied into the shared global memory 138 from the managed drives 132, and sent to the host application 104 via one of the compute nodes 116₁-116₄. In the case where the IO 146 is a write command, in some embodiments the storage system 100 copies a block being written into the shared global memory 138, marks the data as dirty, and creates new metadata that maps the address of the data on the production device 140 to a location to which the block is written on the managed drives 132. The shared global memory 138 may enable the production device 140 to be reachable via all of the compute nodes 116₁-116₄ and paths, although the storage system 100 can be configured to limit use of certain paths to certain production devices 140.

If a compute node receives an IO, the compute node will access the metadata for the IO to determine where the data is stored on the disk array (which array, which disk, which track) and then issue the memory access operation on the disk array. If the compute node does not have the metadata and the metadata is contained in the memory of another compute node, it will need to first retrieve the metadata from the other compute node. As described in greater detail herein, a storage system is proposed in which each compute node is able to perform atomic operations and RDMA operations on each memory of every other compute node without requiring intervention by the other compute node.

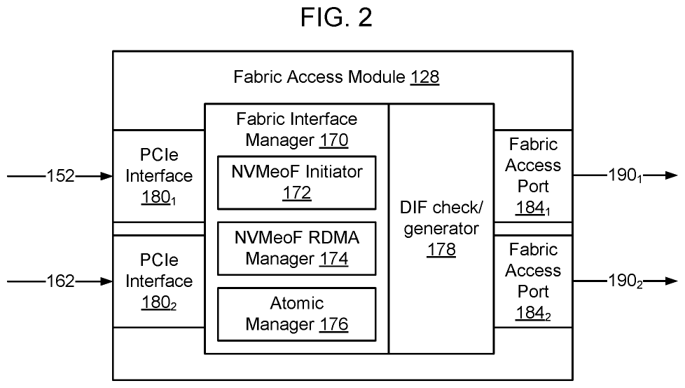

FIG. 2 is a functional block diagram of an example fabric access module 128 according to some embodiments. As shown in FIG. 2, in some embodiments the fabric access module 128 includes a set of PCIe interfaces 180₁, 180₂, a fabric interface manager 170, a DIF check/generator 178, and first and second fabric access ports 184₁, 1842. In some embodiments, first and second PCIe interfaces 180₁, 180₂, are connected to links 152, 162, to enable each compute node 116 of the storage engine 118 to initiate operations on the fabric access module 128. Fabric access ports 184 connect to links 190₁, 190₂, which are respectively connected to redundant fabrics 136. For example, as shown in FIG. 1, in some embodiments two fabrics 136A, 1366 are used to interconnect the storage engines 118 and storage arrays 130, for redundancy, to ensure that the storage arrays are accessible by storage engines in the event of a failure of one of the fabrics 136.

In some embodiments, the fabric interface manager 170 includes a NVMeoF (Non-Volatile Memory express over Fabrics) initiator. NVMeoF is a network protocol, like iSCSI, used to communicate between a host and a storage system over a network (aka fabric). In some embodiments, the NVMeoF initiator initiates transactions on the fabrics 136, for example to perform read and write transactions on disk arrays 130.

In some embodiments, the fabric interface manager 170 includes RDMA manager 174. RDMA (Remote Direct Memory Access) is a direct memory access operation from the memory of one compute node 116 into that of another compute node 116 without involving either one's operating system. RDMA manager 174 manages RDMA operations targeting memory 124 on compute node 116. RDMA manager 174 also manages RDMA operations by compute node 116 on memories 124 of other compute nodes in the storage system 100. Since all compute nodes 116 can implement memory access operations on local memory 124 of each of the other compute nodes, without requiring the other compute node 116 to become involved in the memory access operation, the memory access operation is greatly simplified, thus improving the efficiency of the storage engine 118 and reducing latency in accessing data.

In some embodiments, the fabric interface manager 170 includes atomic manger 176. Atomic operations by CPU 122 on compute node 116 are managed by atomic manager 176. Similarly, atomic operations by other compute nodes on memory 124 of compute node 116 are implemented using atomic manager 176. In some embodiments, any compute node connected to fabric 136 can initiate atomic operations on the memory 124 of the associated compute node. Atomic manager 176 serializes operation by multiple nodes on the same address that are received from the fabric, guaranteeing the atomic nature of the operations.

For example, referring to FIG. 1, compute node 116₁ can initiate an atomic operation on its own memory 124₁ using atomic manager 176 of compute node 116₁'s fabric access module 128₁. Likewise, compute nodes 116₂, 116₃, and 116₃ can initiate an atomic operation on its compute node 116₁'s memory 124₁ using fabric access module 128₁. In some embodiments, all atomic operations normally target the native host adapter on each compute node. Thus, atomic operations on compute node 116₁ preferably are implemented through 116₁'s fabric access module 128₁, atomic operations on compute node 116₂ preferably are implemented through 116₂'s fabric access module 128₂, etc. Targeting the compute node's host adapter facilitates proper atomic consistency when a node's adapter fails.

In some embodiments, fabric access module 128 includes a DIF (Data Integrity Field) check/generator 178. DIF is an approach to protecting data integrity in a computer data storage, that seeks to prevent data corruption. DIF generator aspect of DIF check/generator 178, in some embodiments, adds DIF information such as a hash of the data or a cyclic redundancy code, when the data passes through fabric access module 128 onto fabric 136. The added DIF information enables a recipient to determine whether data has been corrupted. The DIF check aspect of the DIF check/generator 178 uses DIF information contained in data that is received by fabric access module 128 from fabric 136, to determine whether the data has been corrupted. By adding DIF check information and using the DIF check information, the fabric access module 128 can help ensure the integrity of the data as the data is passed between components of the storage system 100.

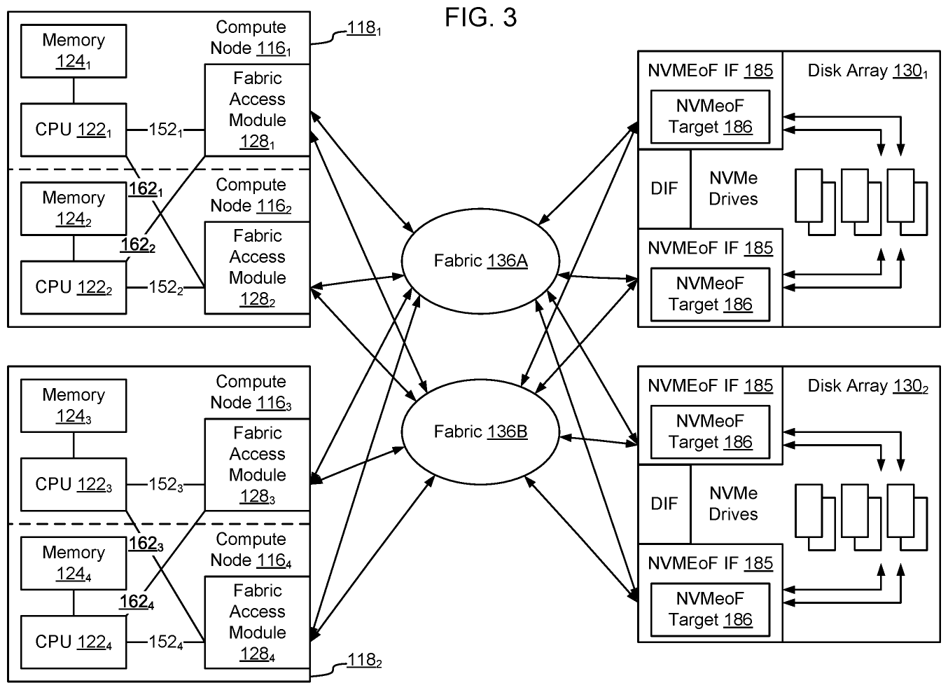

FIG. 3 is a functional block diagram of a storage system 100 having a first storage engine 118₁ and a second storage engine 118₂. Although only two storage engines are shown in FIG. 3 for ease of illustration, the storage system 100 may have any number of storage engines. As shown in FIG. 3, in some embodiments each storage engine 118 has dual compute nodes 116, and each of the dual compute nodes 116 has a respective fabric access module. The compute node's respective fabric access module 128, in some embodiments, is primarily responsible for managing access to the compute node's memory 124. Accordingly, as discussed above in connection with FIG. 2, operations by compute node 116 on disk arrays 130, RDMA operations, and atomic operations are all managed by the compute node's fabric access module 128.

In the embodiment shown in FIG. 3, compute node 116₁ includes a fabric access module 128₁, and is connected by PCIe bus 152₁ to fabric access module 128₁. Additionally, compute node 116₁ is connected by PCIe bus 162₁ to the fabric access module 128₂ of the other compute node 116₂ of the first storage engine 118₁. Compute node 116₂ includes a fabric access module 128₂, and is connected by PCIe bus 152₂ to fabric access module 128₂. Additionally, compute node 116₂ is connected by PCIe bus 1622 to the fabric access module 128₁ of the other compute node 116₁ of the first storage engine 118₁. Dually connecting the PCIe root complex of each compute node to two fabric access modules 128 provides redundant fabric access for the compute node 116 to the fabric 118 in the event of a failure of one of the fabric access modules 128. In other embodiments, each compute node is only connected to its own fabric access module 128 rather than being redundantly cross-connected to both compute nodes' fabric access modules 128.

In the embodiment shown in FIG. 3, each disk array 130₁, 130₂, includes a first NVMeoF interface 185₁ connected to the first fabric 136A and a second NVMeoF interface 1852 connected to the second fabric 136B. Either fabric can be used to access disk arrays 130₁, 130₂, with both fabrics active-active. In some embodiments, NVMeoF interface 185 is a smart network interface card (NIC) with a corresponding memory and switch configured to enable the NVMeoF to be a target 186 of NVMeoF transactions.

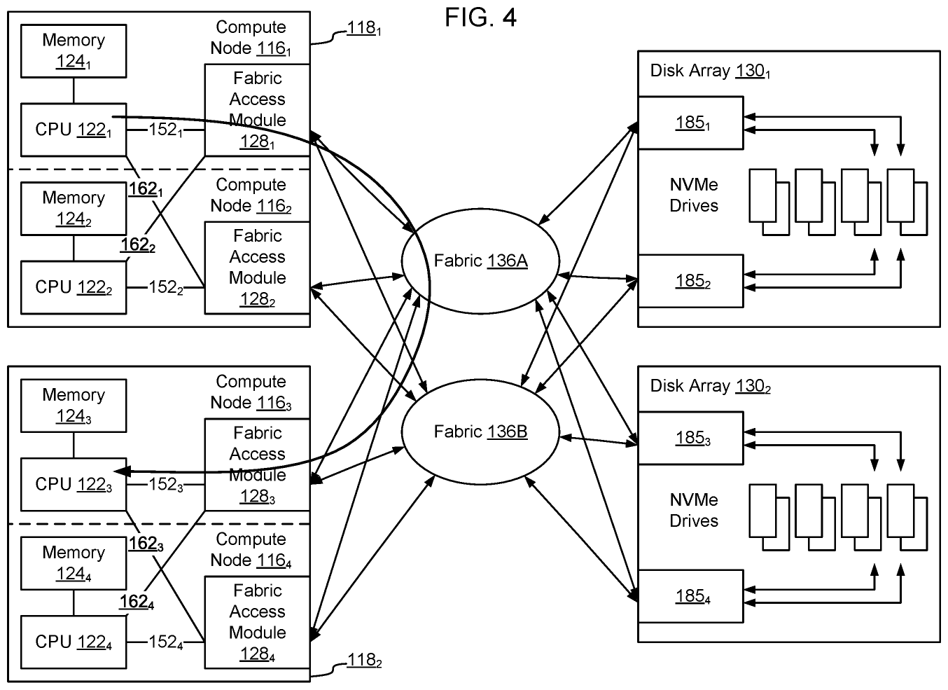

FIGS. 4-12 show several transactions between components of the storage system 100. As shown in connection with FIGS. 4-12, providing the compute nodes 116 with the described fabric access module 128, and the disk arrays 130 with a NVMeoF interface 185 enables all compute nodes to have direct access to each of the v arrays 130. No one compute node 116 is responsible for any particular disk array 130, but rather all disk arrays 130 are directly accessible on fabric 136 by any compute node 116. Further, each compute node 116 is able to directly access the memory of any other compute node 116 over fabric 136. By providing any-to-any connectivity within the storage system 100, the storage system becomes much more resilient when compared with a system in which there is a relational dependency between particular compute node 116 and corresponding disk arrays 130 e.g. when compared with an embodiment in which each compute node is responsible for managing one or more disk arrays 130.

FIG. 4 is a functional block diagram of the storage system of FIG. 3 showing compute node 116 to compute node 116 messaging, according to some embodiments. The architecture shown in FIG. 3 enables each compute node 116 to directly message each other compute node 116. FIG. 4 shows an example message from compute node 116₁ to compute node 116₄. As shown in FIG. 4, the CPU of compute node 116₁ generates a message and passes the message through its fabric access module 128₁ onto one of the fabrics 136. Either fabric 136 can be used. The message, when received by the target fabric access module 128₃ passes the message to the target node CPU 122₃.

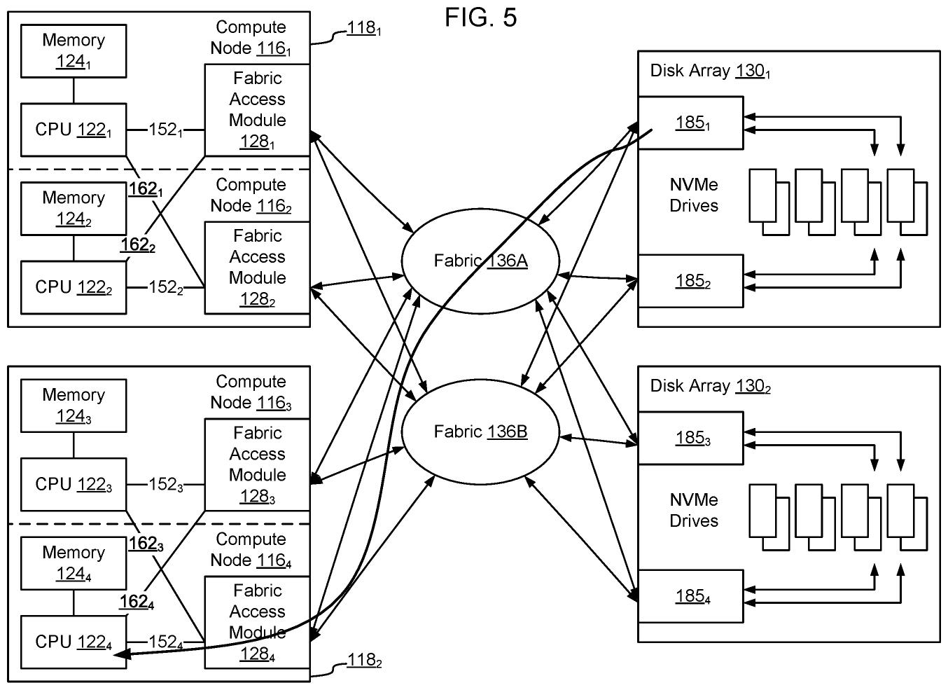

FIG. 5 is a functional block diagram of the storage system of FIG. 3 showing disk array 130 to compute node 116 messaging, according to some embodiments. The architecture shown in FIG. 3 enables each disk array 130 to directly message each compute node 116. FIG. 5 shows an example message from disk array 130₁ to compute node 116₄. As shown in FIG. 5, a message from NVMeoF fabric interface 185₁ is generated by disk array 130₁ and passed on one of the fabrics to the fabric access module 128₄ of compute node 116₄. Either fabric 136 can be used. The message, when received by the target fabric access module 128₄, is passed by the target fabric access module 128₄ to the target compute nodes CPU 122₄.

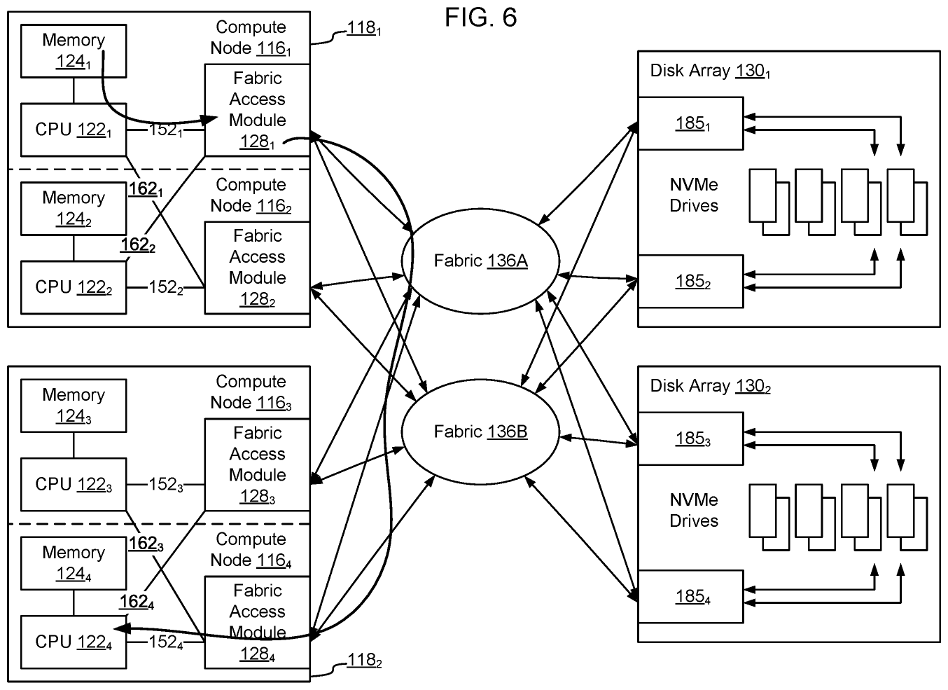

FIG. 6 is a functional block diagram of the storage system of FIG. 3 showing a metadata read operation by compute node 4 from compute node 1, according to some embodiments. The memory/atomic boundary at compute node 116₁, in some embodiments, is the compute node 116₁'s fabric access module 128₁. The architecture shown in FIG. 3 enables each compute node 116 to directly implement a metadata read operation on the memory 124 of any other compute node 116. For example, as shown in FIG. 6, in connection with a metadata read operation, metadata contained in compute node 116₁'s memory 124₁ is read by fabric interface atomic manager 176 of fabric access module 128₁, and forwarded on fabric 136 to compute node 116₄. The fabric access manager 128 atomic manager 176 serializes this read with respect to all other accesses to the same address that are received from the fabric, guaranteeing the atomic nature of the read operation. Fabric access module 128₄ then passes the metadata to CPU 122₄. In this manner, metadata contained by any compute node 116 is accessible to all compute nodes 116 in the storage system 100.

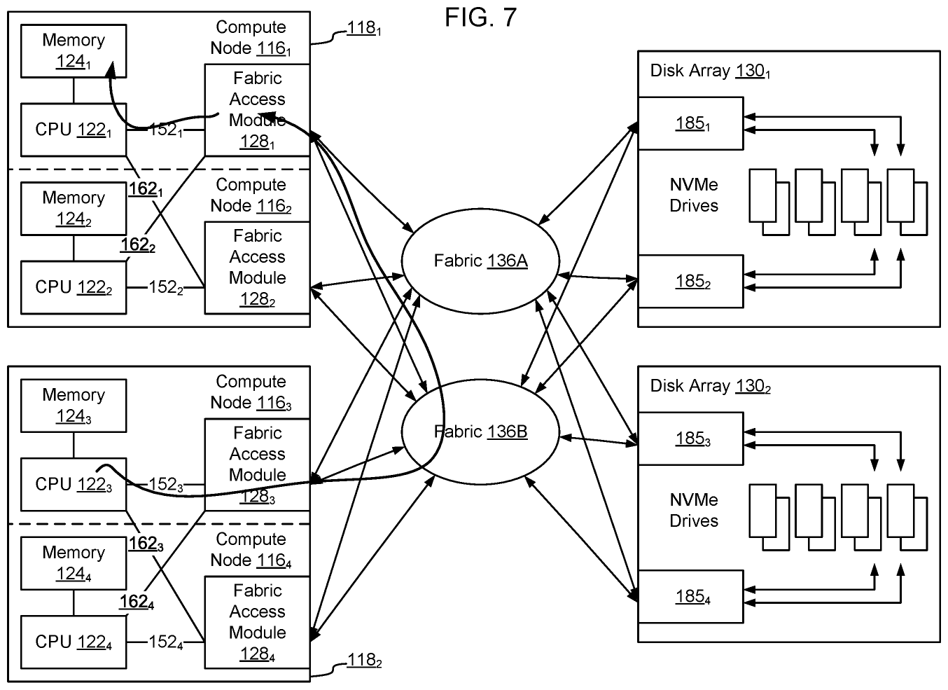

FIG. 7 is a functional block diagram of the storage system of FIG. 3 showing a metadata write operation by compute node 116₃ to the memory 124₁ of compute node 116₁, according to some embodiments. The memory/atomic boundary at compute node 116₁, in some embodiments, is the compute node 116₁'s fabric access module 128₁. The architecture shown in FIG. 3 enables each compute node 116 to directly implement a metadata write operation on the memory 124 of any other compute node 116. For example, as shown in FIG. 7, in connection with a metadata write operation, metadata associated with a location of data stored by storage system is passed by CPU 122₃ of compute node 116₃ to the fabric access modules 128₃. Fabric access module 128₃, forwards the metadata write operation on fabric 136 to compute node 116₁. Fabric access module 128₁ writes the metadata to compute node 116₁'s memory 124₁. The fabric access manager 128₁ atomic manager 176 serializes this write with respect to all other accesses to the same address that are received from the fabric, guaranteeing the atomic nature of the write operation. In this manner, metadata can be written by compute node 116 to the memory of any other compute node 116 in the storage system 100.

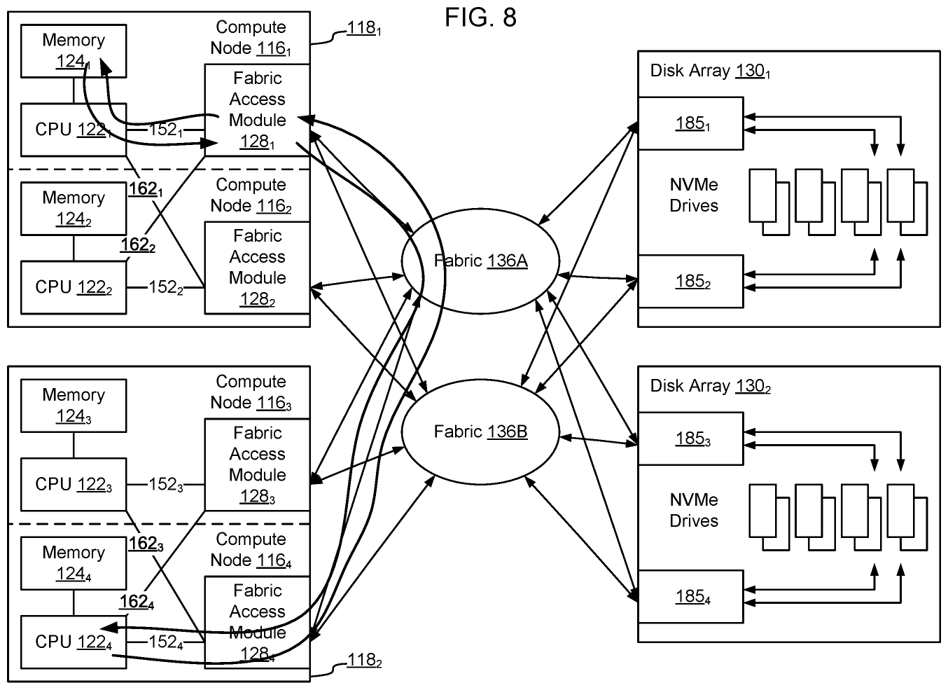

FIG. 8 is a functional block diagram of the storage system of FIG. 3 showing metadata atomic read/modify/write operation for compute node 116₄ of compute node 116₁ memory, according to some embodiments. Operations on compute node 116₁'s memory 124₁ are managed by fabric access module 128₁. As shown in FIG. 8, the fabric atomic manager 176 of fabric access module 128₁ reads the metadata to be modified, performs the indicated operation, and writes the result back, and passes the data back to compute node 116₁. The operations are serialized with respect to all other accesses to the same addresses that are received from the fabric, guaranteeing the atomic nature of the read-modify-write operation. In this manner, any compute node 116 can implement read/modify/write atomic operations on metadata contained by any of the other compute nodes 116 in the storage system 100.

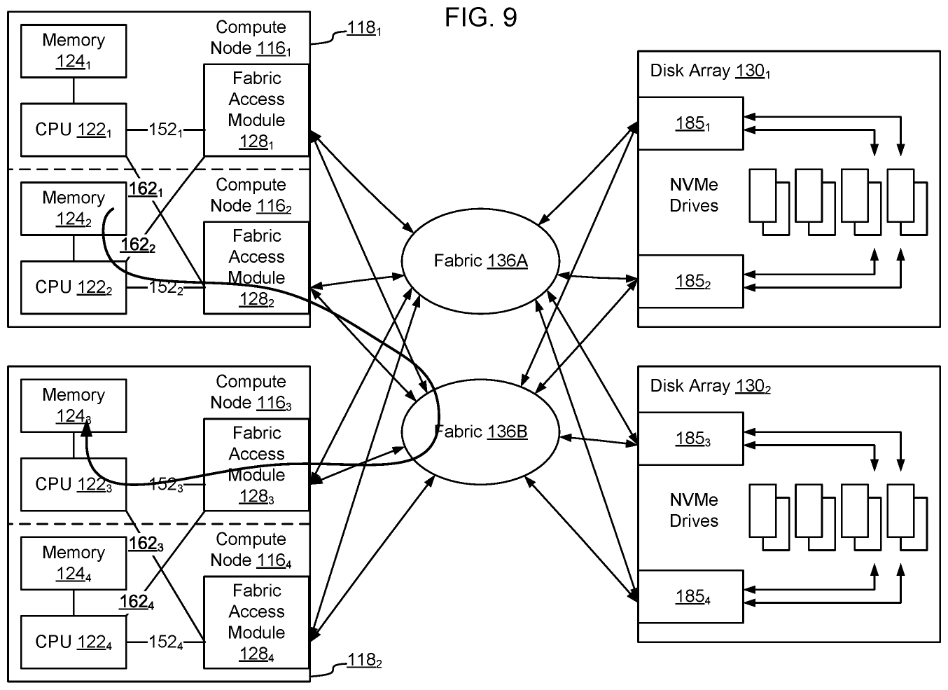

FIG. 9 is a functional block diagram of the storage system of FIG. 3 showing a Remote Direct Memory Access (RDMA) read operation by compute node 116₃ on memory 124₂ of compute node 116₂. In some embodiments, the RDMA read operation on compute node 116₂ is managed by NVMeoF RDMA manager 174 of fabric access module 128₂ on compute node 116₂. As shown in FIG. 9, fabric access module 128₂ performs the memory read operation on memory 124₂ and passes the data on fabric 136 to the fabric access module 128₃ of compute node 116₃. Fabric access module 128₃ places the data in memory 124₃ and notifies CPU 122₃. In some embodiments RDMA manager 174 on compute node 116₃ manages the RDMA process for compute node 116₃. In this manner, any compute node 116 can perform an RDMA read operation on any memory 124 of any other compute node 116 in the storage system.

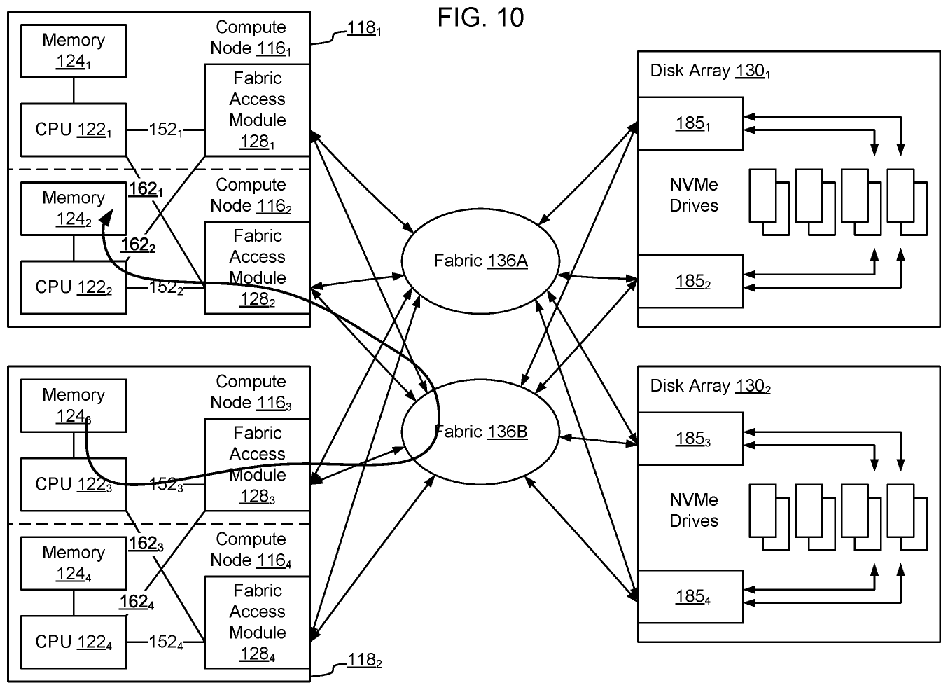

FIG. 10 is a functional block diagram of the storage system of FIG. 3 showing a write operation by compute node 116₃ to memory 124₂ of compute node 116₂. In some embodiments, the RDMA write operation on compute node 116₂ is managed by NVMeoF RDMA manager 174 of fabric access module 128₂ on compute node 116₂. As shown in FIG. 10, fabric access module 128₃ of compute node 116₃ forwards the memory write operation on fabric 136 to the fabric access module 128₂ of compute node 116₂. Fabric access module 128₂ places the data in memory 124₂ and notifies CPU 122₂. In some embodiments RDMA manager 174 on compute node 116₂ manages the RDMA process for compute node 116₂. In this manner, any compute node 116 can perform an RDMA write operation on any memory 124 of any other compute node 116 in the storage system.

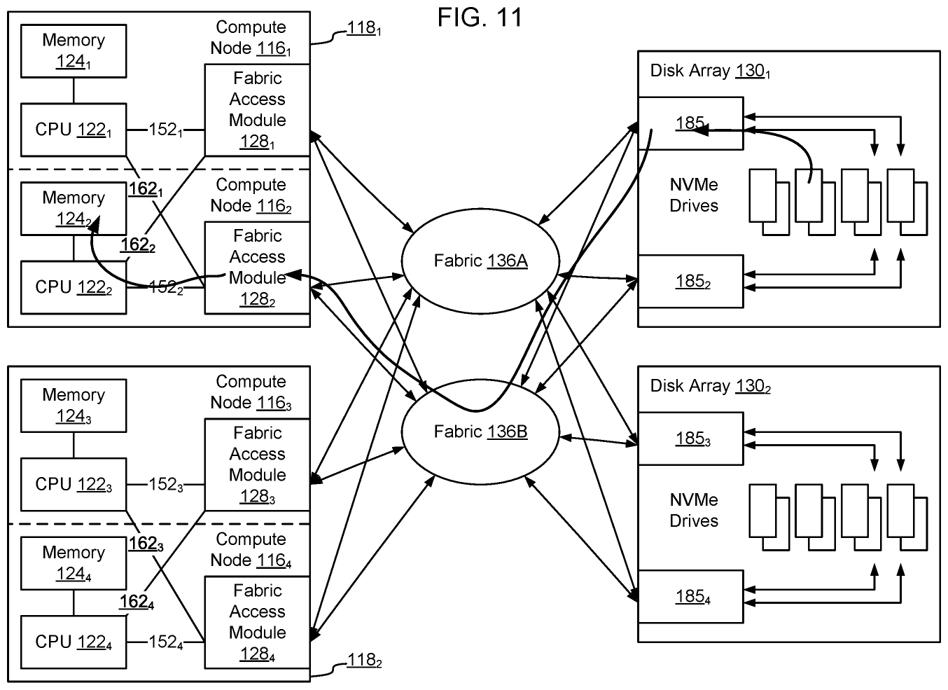

FIG. 11 is a functional block diagram of the storage system of FIG. 3 showing a NVMeoF read operation from a drive 132 on disk array 130₁ by compute node 116₂, according to some embodiments. In FIG. 11, the fabric access module 128₂ on compute node 116₂ is the NVMeoF initiator, and the NVMeoF interface 185₁ on disk array 130₁ is the NVMeoF target. As shown in FIG. 11, requested data is retrieved by NVMeoF interface 185₁ on disk array 130₁. NVMeoF interface 185₁ forwards the data on fabric 136 to fabric access module 128₂. NVMeoF initiator 172 of fabric access module 128₂ places the data into memory 124₂ and notifies CPU 122₂. In this manner, any compute node 116 can implement a read operation on any disk 132 of any disk array 130 in the storage system 100.

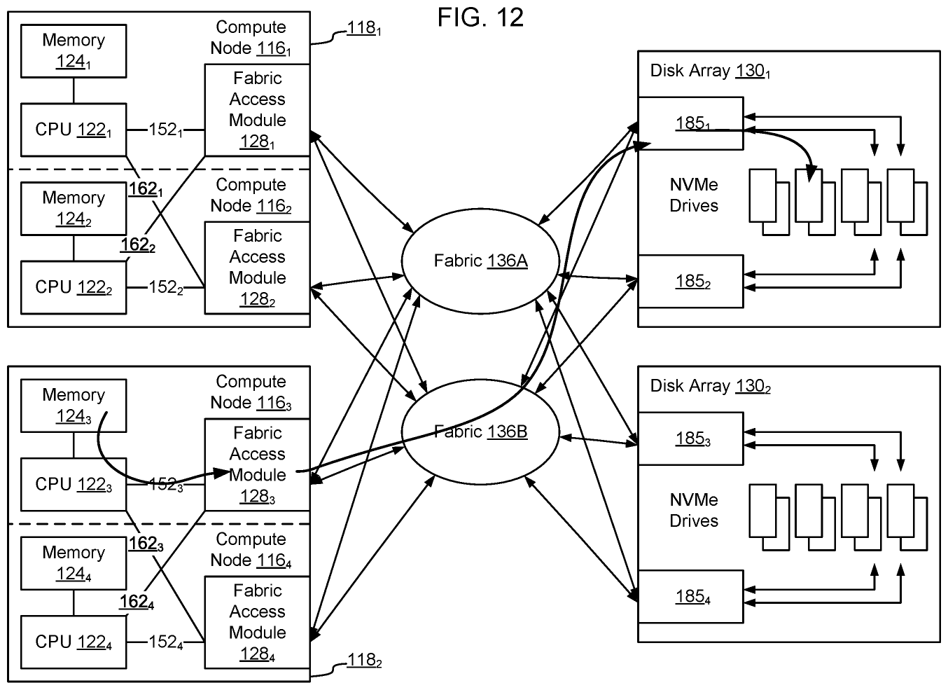

FIG. 12 is a functional block diagram of the storage system of FIG. 3 showing a NVMeoF write from compute node 116₃ to one or more disks 132 of disk array 130₁, according to some embodiments. In FIG. 12, the fabric access module 128₃ on compute node 116₃ is the NVMeoF initiator, and the NVMeoF interface 185₁ on disk array 130₁ is the NVMeoF target. As shown in FIG. 12, NVMeoF initiator 172 of fabric access module 128₃ retrieves data from memory 124₃ and forwards the data on fabric 136 to NVMeoF interface 185₁ of disk array 130₁. NVMeoF interface 185₁ writes the data to disks 132. In this manner, any compute node 116 can implement a write operation on any disk 132 of any disk array 130 in the storage system.

In each of the scenarios described above in connection with FIGS. 4-12, DIF check/generator is used to add DIF information to the packets of data or to use DIF information contained with the packets of data to perform a data integrity check. Although a DIF check/generator has been shown in FIG. 2 as implemented in the fabric access module 128, in some embodiments DIF check/generator is also implemented on NVMeoF Interface 185 (see FIG. 3) to enable the disk arrays 130 to also implement data integrity checks within storage system 100.

The methods described herein may be implemented as software configured to be executed in control logic such as contained in a Central Processing Unit (CPU) or Graphics Processing Unit (GPU) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible computer readable medium such as random-access memory, a computer memory, a disk, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A storage system, comprising:
a first storage engine having a first compute node, a second compute node, a first fabric adapter, and a second fabric adapter, the first compute node having a first memory and the second compute node having a second memory;
a second storage engine having a third compute node, a fourth compute node, a third fabric adapter, and a fourth fabric adapter, the third compute node having a third memory and the fourth compute node having a fourth memory;
a first disk array;
a second disk array;
a first fabric interconnecting the first storage engine, the second storage engine, the first disk array, and the second disk array; and
a second fabric interconnecting the first storage engine, the second storage engine, the first disk array, and the second disk array;
wherein the first fabric adapter, the second fabric adapter, the third fabric adapter, and the fourth fabric adapter are configured to enable any compute node to access the memory of any other compute node.

2. The storage system of claim 1, wherein each of the first fabric adapter, the second fabric adapter, the third fabric adapter, and the fourth fabric adapter is configured to enable any compute node to access any disk of any disk array.

3. The storage system of claim 1, wherein each of the first fabric adapter, the second fabric adapter, the third fabric adapter, and the fourth fabric adapter is configured to implement atomic operations on each of the other compute nodes.

4. The storage system of claim 1, wherein each of the first fabric adapter, the second fabric adapter, the third fabric adapter, and the fourth fabric adapter is configured to enable each compute node to message each of the other compute nodes.

5. The storage system of claim 1, wherein accessing the memory of any other compute node includes implementing metadata read/write/atomic operations on the memory of any other compute node.

6. The storage system of claim 1, wherein each fabric access module further comprises a respective Data Integrity Field (DIF) check/generator configured to add DIF information to data transmitted through the fabric adapter.

7. The storage system of claim 6, wherein accessing the memory of any other compute node includes implementing Remote Direct Memory Access (RDMA) operations with DIF on the memory of any other compute node.

8. A compute node, comprising:
a CPU;
a memory; and
a fabric adapter connected by a fabric to a set of other compute nodes, each other compute node having a respective CPU and respective memory, the fabric adapter comprising:
a Non-Volatile Memory express over Fabric (NVMeoF) initiator configured to manage NVMeoF memory operations on fabric-attached disk arrays;
a NVMeoF Remote Direct Memory Access (RDMA) manager configured to manage RDMA operations on the memory of the compute node received over the fabric from the other fabric-attached compute nodes; and
an atomic manager configured to manage atomic operations by the other fabric-attached compute nodes on the memory of the compute node.

9. The compute node of claim 8, wherein the atomic manager is further configured to manage metadata read/write operations by the other fabric-attached compute nodes on the memory of the compute node.

10. The compute node of claim 8, wherein the NVMeoF RDMA manager is further configured to manage RDMA operations by the compute node on the respective memories of the other fabric attached compute nodes.

11. The compute node of claim 8, wherein the atomic manager is configured to manage atomic operations by the compute node on the respective memories of the other fabric attached compute nodes.

12. The compute node of claim 8, wherein the fabric adapter is configured to enable messaging between the CPU by the compute node and respective CPUs of other fabric attached compute nodes.

13. The compute node of claim 8, wherein the fabric access module further comprises a Data Integrity Field (DIF) check/generator configured to add DIF information to data transmitted through the fabric adapter.

14. The compute node of claim 13, wherein the DIF check/generator is further configured to use DIF information associated with data received from the fabric to check an integrity of data received through the fabric adapter.

15. A method of enabling communication between compute nodes and disk arrays, comprising
interconnecting, by an interconnect fabric, a first storage engine, a second storage engine, a first disk array, and a second disk array, wherein:
the first storage engine comprises a first compute node, a second compute node, a first fabric adapter, and a second fabric adapter, the first compute node having a first memory and the second compute node having a second memory, and
the second storage engine comprises a third compute node, a fourth compute node, a third fabric adapter, and a fourth fabric adapter, the third compute node having a third memory and the fourth compute node having a fourth memory;
enabling atomic operations, over the interconnect fabric, by each of the first, second, third, and fourth compute nodes via the compute node's respective fabric adapter, on the respective memory of each of the first, second, third, and fourth compute nodes.

16. The method of claim 15, further comprising enabling metadata read/write operations, over the interconnect fabric, by each of the first, second, third, and fourth compute nodes via the compute node's respective fabric adapter on the respective memory of each of the first, second, third, and fourth compute nodes.

17. The method of claim 15, further comprising enabling Remote Direct Memory Access (RDMA) operations, over the interconnect fabric, by each of the first, second, third, and fourth compute nodes via the compute node's respective fabric adapter on the respective memory of each of the first, second, third, and fourth compute nodes c.

18. The method of claim 15, further comprising enabling disk access operations, over the interconnect fabric, by each of the first, second, third, and fourth compute nodes via the compute node's respective fabric adapter on each of the first and second disk arrays.

19. The method of claim 15, wherein each fabric access module further comprises a Data Integrity Field (DIF) check/generator, and wherein the method further comprises using the DIF check/generator to add DIF information to data transmitted through the fabric adapter before the data is forwarded on the interconnect fabric.

20. The method of claim 19, further comprising using the DIF check/generator to read DIF information from data received from the interconnect fabric and using the DIF information to determine the validity of the data received from the interconnect fabric.
